(19) United States
(12) Patent Application Publication
(10) Pub. No.: US 2007/0024412 A1
(43) Pub. Date: Feb. 1, 2007

(54) Over-current protection device

(76) Inventors: Shau Chew Wang, Taipei City (TW); Fu Hua Chu, Taipei City (TW); Kuo Chang Lo, Taipei City (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/452,343

(22) Filed: Jun. 14, 2006

(30) Foreign Application Priority Data
Jul. 28, 2005 (TW) 094125547

(51) Int. Cl. H01C 7/13; H01C 7/10

(52) U.S. Cl. 338/22 R

(57) ABSTRACT

The present invention discloses an over-current protection device comprising two metal foils and a positive temperature coefficient (PTC) material layer. The PTC material layer is sandwiched between the two metal foils and contains at least one crystalline polymer, a non-oxide electrically conductive ceramic powder and a non-conductive filler. The non-oxide electrically conductive ceramic powder exhibits a certain particle size distribution. The PTC material layer presents resistivity below 0.1 Ω-cm.

### BACKGROUND OF THE INVENTION

1. Field of the Invention

The present invention relates to an over-current protection device and, more particularly, to an over-current protection device comprising a positive temperature coefficient (PTC) conductive material. The over-current protection device presents better resistivity and resistance repeatability, especially suitable to the protection of the power source used in portable communication applications.

2. Description of the Prior Art

The resistance of PTC conductive material is sensitive to temperature change. With this property, the PTC conductive material can be used as current-sensing material and has been widely used in over-current protection devices and circuits. The resistance of the PTC conductive material remains at a low value at room temperature so that the over-current protection device or circuits can operate normally. However, if an over-current or an over-temperature situation occurs, the resistance of the PTC conductive material will immediately increase at least ten thousand times (over 10⁴ ohm) to a high resistance state. Therefore, the over-current will be counterchecked and the objective of protecting the circuit elements or batteries is achieved.

In general, the PTC conductive material contains at least one crystalline polymer and conductive filler. The conductive filler is dispersed uniformly in the crystalline polymer(s). The crystalline polymer is mainly a polyolefin polymer such as polyethylene. The conductive filler(s) is mainly carbon black, metal particles and/or non-oxide ceramic powder; for example, titanium carbide or tungsten carbide.

The conductivity of the PTC conductive material depends on the content and type of the conductive fillers. Generally speaking, the carbon black having a rough surface provides better adhesion with the polyolefin polymer and accordingly a better resistance repeatability is achieved. However, the conductivity of the carbon black is lower than that of the metal particles. If the metal particles are used as the conductive filler, their larger particle size results in less uniform dispersion, and they are prone to be oxidized to cause high resistance. To effectively reduce the resistance of the over-current protection device and prevent oxidation, the ceramic powder tends to be used as the conductive filler in a low-resistance PTC conductive material. Since it lacks a rough surface like carbon black, the ceramic powder exhibits poor adhesion with the polyolefin polymer, and consequently, the resistance repeatability of the PTC conductive material is not well controlled. In prior arts, to improve the adhesion between the metal particles and the polyolefin polymer, a coupling agent will be added into the conventional PTC conductive material with the ceramic powder as the conductive filler. The coupling agent may be an anhydride compound or a silane compound. However, the total resistance of the PTC conductive material after the coupling agent is added cannot be reduced effectively.

Currently, a low-resistance (about 20 mΩ) PTC conductive material with nickel as the conductive filler is available in the public market, but it can only sustain a voltage up to 6V. If the nickel is not isolated well from the air, it is prone to be oxidized after a period, and this results in increasing resistance. In addition, the resistance repeatability of the low-resistance PTC conductive material is not satisfied after tripping.

### SUMMARY OF THE INVENTION

The objective of the present invention is to provide a high-voltage over-current protection device. By adding a conductive powder (conductive filler) with a certain particle size distribution, the high-voltage over-current protection device exhibits excellent resistance, high voltage endurance and resistance repeatability.

In order to achieve the above objective, the present invention discloses a high-voltage over-current protection device comprising two metal foils and a PTC material layer. Each of the two metal foils exhibits a rough surface with nodules and contacts the PTC material layer directly and physically. The PTC material layer is sandwiched between the two metal foils and comprises at least one crystalline polymer, a non-conductive filler and a non-oxide electrically conductive ceramic powder. The particle size distribution is preferably between 0.01 μm and 30 μm, and more preferably between 0.1 μm and 10 μm. The non-oxide electrically conductive ceramic powder exhibits resistivity below 500 μΩ-cm and is dispersed in at least one crystalline polymer. The crystalline polymer(s) is (are) selected from the group consisting of high-density polyethylene (HDPE), low-density polyethylene (LDPE), polypropylene and polyvinyl fluoride.

The non-oxide electrically conductive ceramic used in the present invention is selected from: (1) metal carbide (e.g., titanium carbide (TiC), tungsten carbide (WC), vanadium carbide (VC), zirconium carbide (ZrC), niobium carbide (NbC), tantalum carbide (TaC), molybdenum carbide (MoC) and hafnium carbide (HfC)); (2) metal boride (e.g., titanium boride (TiB₂), vanadium boride (VB₂), zirconium boride (ZrB₂), niobium boride (NbB₂), molybdenum boride (MoB₂) and hafnium boride (HfB₂)) and (3) metal nitride (e.g., zirconium nitride (ZrN)).

The non-conductive filler of the present invention is selected from: (1) an inorganic compound with the effects of flame retardant and anti-arcing; for example, zinc oxide, antimony oxide, aluminum oxide, aluminum nitride, boron nitride, fused silica, silicon oxide, calcium carbonate, magnesium sulfate and barium sulfate and (2) an inorganic compound with a hydroxyl group; for example, magnesium hydroxide, aluminum hydroxide, calcium hydroxide, and barium hydroxide. The particle size of the non-conductive filler is mainly between 0.05 μm and 50 μm and the non-conductive filler is 1% to 20% by weight of the total composition of the PTC material layer.

The resistivity of the non-oxide electrically conductive ceramic powder is extremely low (below 500 μΩ-cm) and thus the PTC material layer containing the non-oxide electrically conductive ceramic powder can achieve a resistivity below 0.5 Ω-cm. In general, the resistivity of conventional PTC material does not easily fall below 0.1 Ω-cm. Even if it reaches below 0.1 Ω-cm, the conventional PTC material usually fails to keep voltage endurance due to excessively low resistance of the conventional PTC material. However, the PTC material layer of the over-current protection device of the present invention reaches a resistivity below 0.1 Ω-cm and can sustain a voltage from 12V to 40V.

When the conventional PTC material reaches a resistivity below 0.1 Ω-cm, it usually cannot sustain voltage higher than 12V. In the present invention, a non-conductive filler, an inorganic compound with a hydroxyl group, is added into the PTC material layer to improve the voltage endurance. In addition, the thickness of the PTC material layer is controlled to be over 0.2 mm and thus the voltage endurance of the PTC material layer is enhanced substantially. For the PTC material layer exhibiting extremely low resistivity, the area of the PTC chip that is cut from the PTC material layer is decreased below 50 mm² and the PTC chip still presents the property of low resistance. Accordingly, more PTC chips are produced from one PTC material layer, and thus the cost is reduced.

The over-current protection device further comprises two metal electrode sheets, connected to the two metal foils by solder reflow or by spot welding to form an assembly. The shape of the assembly (the over-current protection device) is axial-leaded, radial-leaded, terminal or surface mount. Also, the two metal foils may connect to a power source to form a circuit such that the over-current protection device protects the circuit during an over-current situation.

### BRIEF DESCRIPTION OF THE DRAWINGS

The invention will be described according to the appended drawing in which:

FIG. 1 illustrates the over-current protection device of the present invention; and

FIG. 2 illustrated another embodiment of the over-current protection device of the present invention.

### DETAILED DESCRIPTION OF THE INVENTION

The following will describe the composition and the manufacturing process of a preferred embodiment of the over-current protection device of the present invention with accompanying figures.

The composition of the PTC material layer used in the over-current protection device includes a first crystalline polymer (HDPE: density: 0.962 g/cm³; weight: 12.11 g), a second crystalline polymer (HDPE: density: 0.943 g/cm³; weight: 3.03 g), a non-conductive filler (magnesium hydroxide: weight: 4.2 g) and a non-oxide electrically conductive ceramic powder (titanium carbide: weight: 85.75 g). In this embodiment, the first and second crystalline are both high-density polyethylene and the titanium carbide exhibits particle size distribution between 0.1 μm and 10 μm.

The manufacturing process of the over-current protection device is described as follows. The raw material is fed into a blender (Hakke 600) at 160° C. for 2 minutes. The procedure of feeding the raw material is: add the high-density polyethylene into the blender; after blending for a few seconds, add the non-oxide electrically conductive ceramic powder (titanium carbide with particle size distribution between 0.1 μm and 10 μm). The rotational speed of the blender is set at 40 rpm. After blending for 3 minutes, the rotational speed increases to 70 rpm. After blending for 7 minutes, the mixture in the blender is drained and thereby a conductive composition with positive temperature coefficient (PTC) behavior is formed.

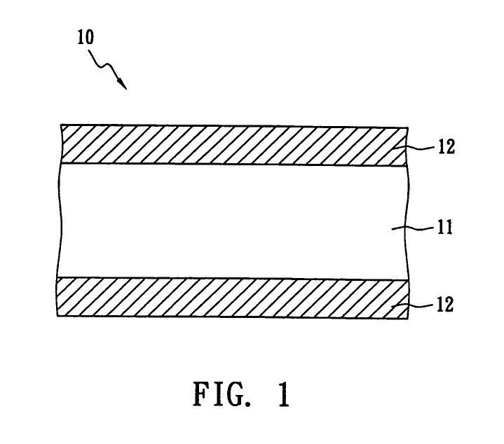

The above conductive composition is loaded into a mold, wherein the top and the bottom of the mold are disposed with a Teflon cloth. The mold is a steel form with an inside thickness of 0.25 mm. First, the mold with the conductive composition is pre-pressed for 3 minutes at 50 kg/cm², 180° C. Then, the gas in the mold is exhausted and the mold is laminated for 3 minutes, at 100 kg/cm², 180° C. The laminating step is repeated once at 150 kg/cm², 180° C. for 3 minutes. After that, a PTC material layer 11 (refer to FIG. 1) is formed and the thickness thereof is 0.45 mm.

Then, the PTC material layer 11 is cut into many squares, each with an area of 20×20 cm². Two metal foils 12 are laminated on the top and bottom surfaces of the PTC material layer 11. The PTC material layer 11 is first sandwiched between the top and the bottom metal foils 12, Teflon cloths (not shown), rubber buffer layers (not shown), Teflon cloths and steel plates (not shown), respectively, all of which are disposed symmetrically on the top and bottom surfaces of the PTC material layer 11, thereby forming a multi-layered (steel plate/rubber buffer layer/Teflon cloths/metal foil/PTC material/metal foil/Teflon cloths/rubber buffer layer/steel plate) structure. The structure is thereafter laminated for 3 minutes at 70 kg/cm², 180° C. Finally, the multi-layered structure is removed from the hot press. The center composite laminate (metal foil/PTC material/metal foil) is cut to form the over-current protection device 10 of 6.5×3.5 mm², which can be used for subsequent tests.

Tables 1-6 show the electrical properties regarding the over-current protection device 10 of the present invention. Table 1 shows the results of the Resistance-Temperature Test of five samples of the PTC material layer 11 used in the over-current protection device 10. Rᵢ(Ω) indicates the initial resistance of the PTC material layer 11 with an average resistance of 5.1 mΩ, which is lower than that, 20 mΩ, of the products available in the public market. Rₚ(Ω) and Rₘₐₓ(Ω) indicate the resistance at the peak of the slope of the resistance-temperature (R-T) curve and the maximal resistance, respectively. R_{RT}(Ω) indicates the post-trip resistance of the PTC material layer 11 after cooling to room temperature. The column of Ratio (R_{RT}/Rᵢ) shows the PTC material layer 11 used in the over-current protection device 10 exhibits excellent resistance repeatability. That is, the resistance can recover to be almost the same as the original resistance.

TABLE 1

| | | | | | Ratio |
|---|---|---|---|---|---|
| | Rᵢ(Ω) | Rₚ(Ω) | Rₘₐₓ(Ω) | R_{RT}(Ω) | (R_{RT}/Rᵢ) |
| Sample 1 | 0.0048 | 345682 | 5637588 | 0.0052 | 1.0833 |
| Sample 2 | 0.0050 | 46803 | 6487712 | 0.0049 | 0.9800 |
| Sample 3 | 0.0052 | 68034 | 5276728 | 0.0066 | 1.2692 |
| Sample 4 | 0.0052 | 7524747 | 7041851 | 0.0070 | 1.3462 |
| Sample 5 | 0.0054 | 256804 | 3944691 | 0.0058 | 1.0741 |
| Average | 0.0051 | 1648414 | 5677714 | 0.0059 | 1.1523 |

In addition, the resistivity of the PTC material layer 11 can be calculated from formula (1) below.

$$ρ = \frac{R \cdot A}{L} \qquad ( 1 )$$

Wherein R is the resistance (Ω) of the PTC material layer 11, A is the area (cm²) of the PTC material layer 11 and L is the thickness (cm) of the PTC material layer 11. We substitute the average of Rᵢ(Ω), 0.0051Ω, for R in formula (1), substitute 6.3×3.5 mm² (=6.5×3.5×10⁻² cm²) for A in formula (1) and substitute 0.45 mm (=0.045 cm) for L in formula (1), and then the resistivity (ρ) is obtained to be 0.0258 Ω-cm, which is obviously smaller than 0.1 Ω-cm.

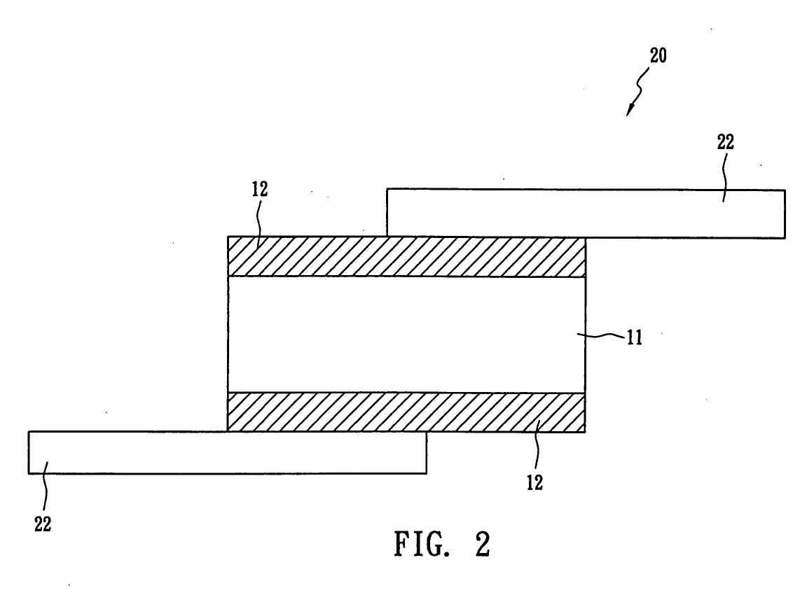

Tables 2-5 show the results of R₁ₘₐₓ tests under different voltage conditions regarding another embodiment of the over-current protection device 20 of the present invention; that is, two metal electrode sheets 22 are connected to the two metal foils 12 attached to the top and bottom surfaces of the PTC material layer 11 (refer to FIG. 2). Rᵢ(Ω) in Tables 2-5 indicates the initial resistance of the over-current protection device 20. R₃₀(Ω) in Table 2 indicates the resistance of the over-current protection device 20 experiencing a condition of 6V/50 A for 60 seconds and then being idle (i.e., no power applied) for 30 minutes. R₃₀(Ω) in Table 3 indicates the resistance of the over-current protection device 20 experiencing a condition of 12V/50 A for 60 seconds and then being idle (i.e., no power applied) for 30 minutes. R₃₀(Ω) in Table 4 indicates the resistance of the over-current protection device 20 experiencing a condition of 16V/50 A for 60 seconds and then being idle (i.e., no power applied) for 30 minutes. R₃₀(Ω) in Table 5 indicates the resistance of the over-current protection device 20 experiencing a condition of 28V/20 A for one hour and then being idle (i.e., no power applied) for 30 minutes. From the column of Ratio (R₃₀/Rᵢ) in each table, the over-current protection device 20 of the present invention indeed exhibits excellent resistance repeatability. Additionally, the over-current protection device 20 of the present invention can sustain a voltage up to 28V, which is much superior to the conventional over-current protection device that only can sustain a voltage up to 6V.

TABLE 2
6 V/50 A (60-second on)

| | Rᵢ (Ω) | R₃₀ (Ω) | Ratio (R₃₀/Rᵢ) |
|---|---|---|---|
| Sample 1 | 0.0161 | 0.0171 | 1.0621 |
| Sample 2 | 0.0162 | 0.0178 | 1.0988 |
| Sample 3 | 0.0166 | 0.0182 | 1.0964 |
| Sample 4 | 0.0166 | 0.0183 | 1.1024 |
| Sample 5 | 0.0168 | 0.0188 | 1.1190 |
| Average | 0.0165 | 0.0180 | 1.0957 |

TABLE 3
12 V/50 A (60-second on)

| | Rᵢ (Ω) | R₃₀ (Ω) | Ratio (R₃₀/Rᵢ) |
|---|---|---|---|
| Sample 1 | 0.0151 | 0.0167 | 1.1060 |
| Sample 2 | 0.0153 | 0.0174 | 1.1373 |
| Sample 3 | 0.0160 | 0.0186 | 1.1625 |
| Sample 4 | 0.0167 | 0.0200 | 1.1976 |
| Sample 5 | 0.0171 | 0.0207 | 1.2105 |
| Average | 0.0160 | 0.0187 | 1.1628 |

TABLE 4
16 V/50 A (60-second on)

| | Rᵢ (Ω) | R₃₀ (Ω) | Ratio (R₃₀/Rᵢ) |
|---|---|---|---|
| Sample 1 | 0.0137 | 0.0170 | 1.2409 |
| Sample 2 | 0.0160 | 0.0200 | 1.2500 |
| Sample 3 | 0.0164 | 0.0210 | 1.2805 |
| Sample 4 | 0.0166 | 0.0210 | 1.2651 |
| Sample 5 | 0.0245 | 0.0360 | 1.4694 |
| Average | 0.0174 | 0.0230 | 1.3012 |

TABLE 5
28 V/20 A (one-hour on)

| | Rᵢ (Ω) | R₃₀ (Ω) | Ratio (R₃₀/Rᵢ) |
|---|---|---|---|
| Sample 1 | 0.0169 | 0.0256 | 1.5148 |
| Sample 2 | 0.0157 | 0.0250 | 1.5924 |
| Sample 3 | 0.0168 | 0.0270 | 1.6071 |
| Sample 4 | 0.0171 | 0.0267 | 1.5614 |
| Sample 5 | 0.0178 | 0.0276 | 1.5506 |
| Average | 0.0169 | 0.0264 | 1.5653 |

Table 6 shows the results of the Surface Temperature Test of the over-current protection device 20 under different conditions of voltages and currents, wherein Rᵢ(Ω) indicates the initial resistance of the over-current protection device 20. The procedure of the Surface Temperature Test is described as follows. First, a sample is applied in a condition of 6V/6 A. After the surface temperature of the sample increases to a stable value, the stable value is recorded. Then, the applied condition changes to 12V/7 A, and the surface temperature is recorded after it becomes stable. Similarly, the applied condition changes to 16V/6 A and then 28V/6 A, and the surface temperature is recorded after it becomes stable. R1ₘₐₓ in Table 6 indicates the resistance after the surface temperature recording and then being idle (i.e., no power supplied) for 30 minutes. For a conventional over-current protection device under the situation of over-current and/or over-voltage, the surface temperature thereof will increase proportionally to the voltage applied. However, from Table 6, the surface temperature of the over-current protection device 20 under the condition of over-current and over-voltage remains stable (from 101° C. to 109° C.), which is independent of the voltage applied. In addition, the over-current protection device 20 exhibits an excellent resistance repeatability that is obviously less then three. (0.0229/0.0178=1.42)

TABLE 6
Surface Temperature Test

| | | 6 V/6 A | 12 V/7 A | 16 V/6 A | 28 V/6 A | |
|---|---|---|---|---|---|---|
| | Rᵢ(Ω) | Temp(° C.) | Temp(° C.) | Temp(° C.) | Temp(° C.) | R1ₘₐₓ(Ω) |
| Sample 1 | 0.0162 | 101 | 102 | 105 | 108 | 0.0230 |
| Sample 2 | 0.0197 | 103 | 104 | 106 | 107 | 0.0246 |
| Sample 3 | 0.0156 | 106 | 108 | 109 | 109 | 0.0179 |
| Sample 4 | 0.0189 | 106 | 107 | 108 | 109 | 0.0237 |
| Sample 5 | 0.0186 | 106 | 108 | 108 | 109 | 0.0254 |
| Average | 0.0178 | 104.4 | 105.8 | 107.2 | 108.4 | 0.0229 |

For the PTC material layer containing the non-oxide electrically conductive ceramic powder having a certain particle size distribution, the over-current protection of the present invention, compared with similar products available in the public market, indeed presents excellent resistance, voltage endurance and resistance repeatability. Also, for the conductive filler (i.e., the non-oxide electrically conductive ceramic powder) is used, which is more stable than metal particles and not easily oxidized; the issue of aging is eliminated.

The devices and features of this invention have been sufficiently described in the above examples and descriptions. It should be understood that any modifications or changes without departing from the spirit of the invention are intended to be covered in the protection scope of the invention.

What is claimed is:

1. An over-current protection device, comprising:
two metal foils; and
a PTC material layer sandwiched between the two metal foils;
wherein the PTC material layer exhibits the resistivity below 0.1 Ω-cm and the thickness above 0.2 mm, and the PTC material layer comprises:
at least one crystalline polymer;
a non-conductive filler; and
a non-oxide electrically conductive ceramic powder consisting essentially of the particle size from 0.1 μm to 10 μm and having a resistivity below 500 μΩ-cm, the non-oxide electrically conductive ceramic powder being dispersed in the crystalline polymer.

2. The over-current protection device of claim 1, wherein the initial resistance of the PTC material layer is below 20 mΩ.

3. The over-current protection device of claim 1, which sustains a voltage up to 28V.

4. The over-current protection device of claim 1, which sustains a current up to 50 A.

5. The over-current protection device of claim 1, which exhibits a resistance repeatability ratio below 3.

6. The over-current protection device of claim 1, wherein the area of the PTC material layer is below 50 mm².

7. The over-current protection device of claim 1, which exhibits a surface temperature below 110° C. under the trip state of over-current protection.

8. The over-current protection device of claim 1, wherein the non-oxide electrically conductive ceramic powder is titanium carbide.

9. The over-current protection device of claim 1, wherein the crystalline polymer comprises high-density polyethylene.

10. The over-current protection device of claim 1, wherein the non-conductive filler is an inorganic compound with a hydroxyl group.

11. The over-current protection device of claim 10, wherein the inorganic compound is magnesium hydroxide.

12. The over-current protection device of claim 1, wherein each of the two metal foils exhibits a rough surface with nodules and contacts the PTC material layer directly and physically.

13. The over-current protection device of claim 1, further comprising two metal electrode sheets that are connected to the two metal foils to form an assembly.

14. The over-current protection device of claim 1, wherein the two metal foils are connected to a power source to form a circuit.
